(19) United States
(12) Patent Application Publication
(10) Pub. No.: US 2003/0078082 A1
(43) Pub. Date: Apr. 24, 2003

(54) Integrated battery seat of mobile telephone

(76) Inventor: Den-Tsai Su, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/015,176

(22) Filed: Oct. 22, 2001

(51) Int. Cl. H04M 1/00

(52) U.S. Cl. 455/572; 455/556

(57) ABSTRACT

The present invention relates to an integrated battery seat of a mobile telephone, having the functions of a digital camera and a digital recorder. The battery seat includes the original structure thereof, and further includes a retractable lens telescopic base, a control circuit board mounted in the inner portion of the battery seat, digital recorder/camera functional buttons mounted on the two sides of the battery seat, and a computer interface socket.

### BACKGROUND OF THE INVENTION

1. Field of the Invention

The present invention relates to an integrated battery seat of a mobile telephone, and more particularly to an integrated battery seat of a mobile telephone, having the functions of a digital camera and a digital recorder, thereby enhancing the integrated function of the mobile telephone.

2. Description of the Related Art

A conventional mobile telephone has various variations in its outer configuration, thereby enhancing the aesthetic quality of the mobile telephone. In addition, the modem mobile telephone may be made light, thin, and short, thereby facilitating the user carrying and using the mobile telephone. However, the conventional mobile telephone does not have the functions of a digital camera and a digital recorder, thereby greatly limiting the versatility of the conventional mobile telephone.

### SUMMARY OF THE INVENTION

The present invention has arisen to mitigate and/or obviate the disadvantage of the conventional mobile telephone.

The primary objective of the present invention is to provide an integrated battery seat of a mobile telephone, wherein the related structures of a digital camera and a digital recorder may be contained in the residual space of the battery seat, and the battery contained in the inner portion of the battery seat may supply the required electric power, thereby forming a battery seat of a mobile telephone having the functions of a digital camera and a digital recorder, thereby enhancing the integrated function of the mobile telephone.

Another objective of the present invention is to provide an integrated battery seat of a mobile telephone, wherein the lens telescopic base having a lens and a viewfinder may be retractably mounted in the battery seat, without occupying space and without affecting the outer appearance of the battery seat of the mobile telephone.

A further objective of the present invention is to provide an integrated battery seat of a mobile telephone, wherein the battery seat includes a control circuit board having a digital signal processor for controlling the functions of a digital camera and a digital recorder, so that the battery seat may maintain its original size.

In accordance with the present invention, there is provided an integrated battery seat of a mobile telephone, comprising:

a control circuit board, mounted in an inner portion of a battery seat, and including a microprocessor, a memory, an image sensor, and an input/output interface, thereby forming a digital camera and digital recorder circuit;

a lens telescopic base, mounted in the battery seat, and capable of springing outward, the lens telescopic base including an image sensing lens a viewfinder;

a recorder push button set and a record hole for forming a peripheral structure to provide a function of a digital recorder; and

a shutter button, for taking digital images;

wherein, the battery seat of the mobile telephone has the functions of a digital camera and a digital recorder.

The battery seat has one side provided with a computer interface socket that is connected to the input/output interface of the control circuit board for connection with a computer.

The battery seat is provided with a lens release button for controlling operation of the lens telescopic base.

The battery seat is provided with an earphone hole for connection with an earphone.

The microprocessor is a structure that may be used to capture images and may be used for digital recording.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an integrated battery seat of a mobile telephone in accordance with the present invention;

FIG. 2 is a perspective view of an integrated battery seat of a mobile telephone in accordance with the present invention;

FIG. 3 is a schematic operational view of the integrated battery seat of a mobile telephone as shown in FIG. 1 in use;

FIG. 4 is a schematic operational view of the integrated battery seat of a mobile telephone as shown in FIG. 1 in use;

FIG. 5 is a structural schematic view of the integrated battery seat of a mobile telephone in accordance with the present invention; and

FIG. 6 is a block view of a practical line of the integrated battery seat of a mobile telephone in accordance with the present invention.

### DETAILED DESCRIPTION OF THE INVENTION

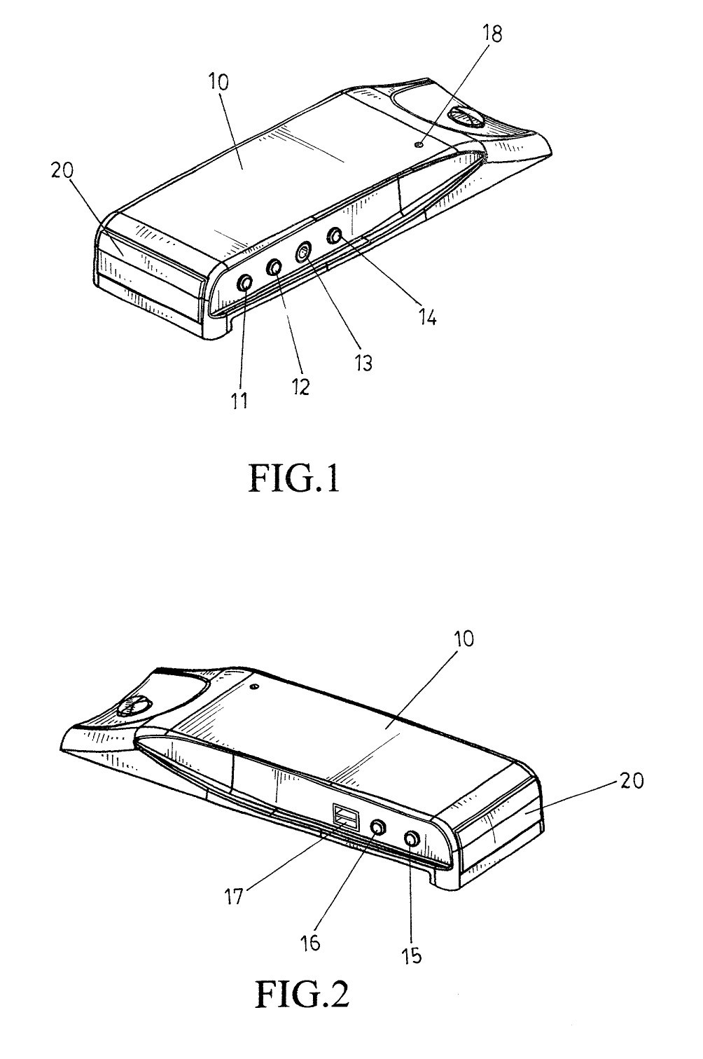

Referring to the drawings and initially to FIGS. 1 and 2, an integrated battery seat of a mobile telephone in accordance with a preferred embodiment of the present invention has the functions of a digital camera and a digital recorder, so that the mobile telephone may be integrated to have multiple functions, thereby eliminating the inconvenience of having to carry a digital camera and a digital recorder additionally.

As shown in FIGS. 1 and 2, the inner space of the battery seat 10 is provided with control circuit boards of a digital camera and a digital recorder. The battery seat 10 has a first side provided with a play button 14, an earphone hole 13, a forward button 12, and a rewind button 11 that are necessary during the recording process, and a record hole 18 is formed on an outer surface of the battery seat 10, thereby forming a battery seat 10 that may the function of a digital recorder.

As shown in FIG. 2, the battery seat 10 has one end provided with a lens telescopic base 20 which is initially retracted into the battery seat 10. The battery seat 10 has a second side provided with a lens release button 15, a shutter button 16, and a computer interface socket 17 that may transmit the data of pictures to a computer.

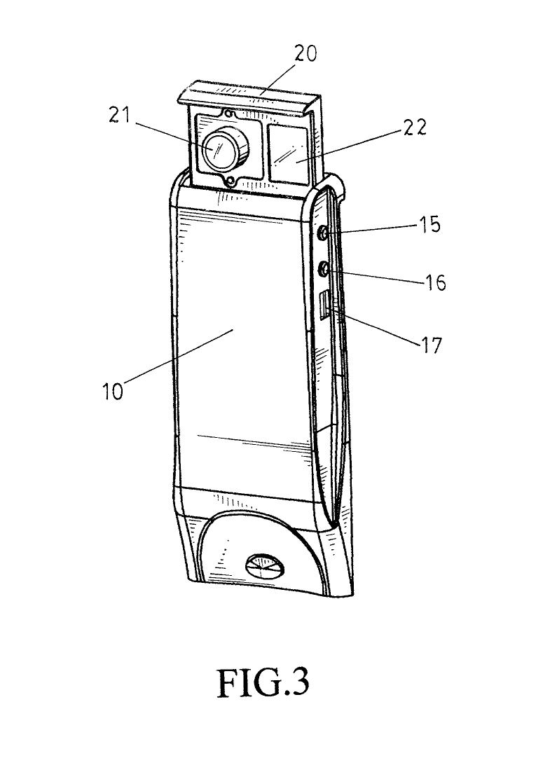

When the lens release button 15 is pressed, the lens telescopic base 20 may be sprung outward as shown in FIG. 3, such that the lens 21 and the viewfinder 22 of the lens telescopic base 20 may be exposed outward.

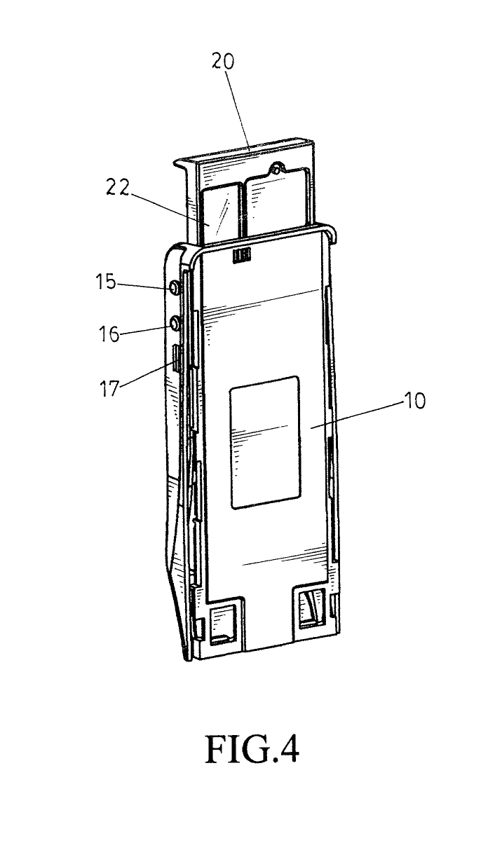

As shown in FIG. 4, the user may hold the battery seat 10 so that the lens 21 and the viewfinder 22 of the lens telescopic base 20 may be used to take photos of an article by pressing the shutter button 16, thereby achieving the function of a digital camera.

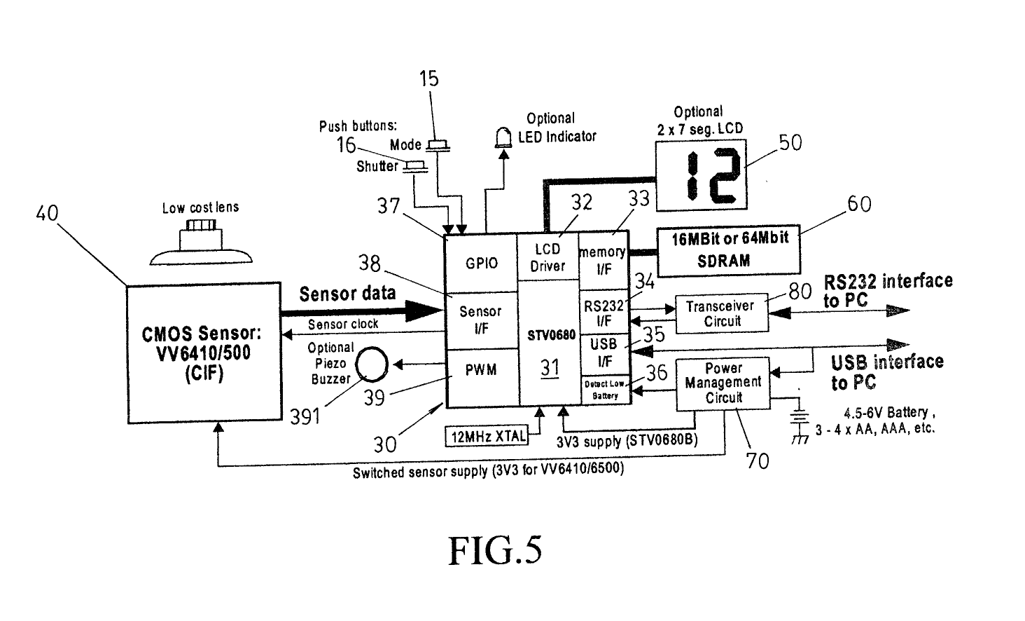

As shown in FIG. 5, the inner control circuit of the present invention includes a single-chip microprocessor 30 whose inner portion is integrated with a digital signal processor 31, a liquid crystal display driver 32, a memory interface 33, a RS232 interface 34, a USB interface 35, an emergency backup battery 36, a GPIO 37, a sensor input interface 38, and a wave width modulation controller 39, and the related interfaces are directly connected with a liquid crystal display 50, a memory 60, a RS232 signal transceiver 80, a power supply 70, a buzzer 391, an image sensor 40, and function buttons, thereby the digital camera and the digital recorder circuit.

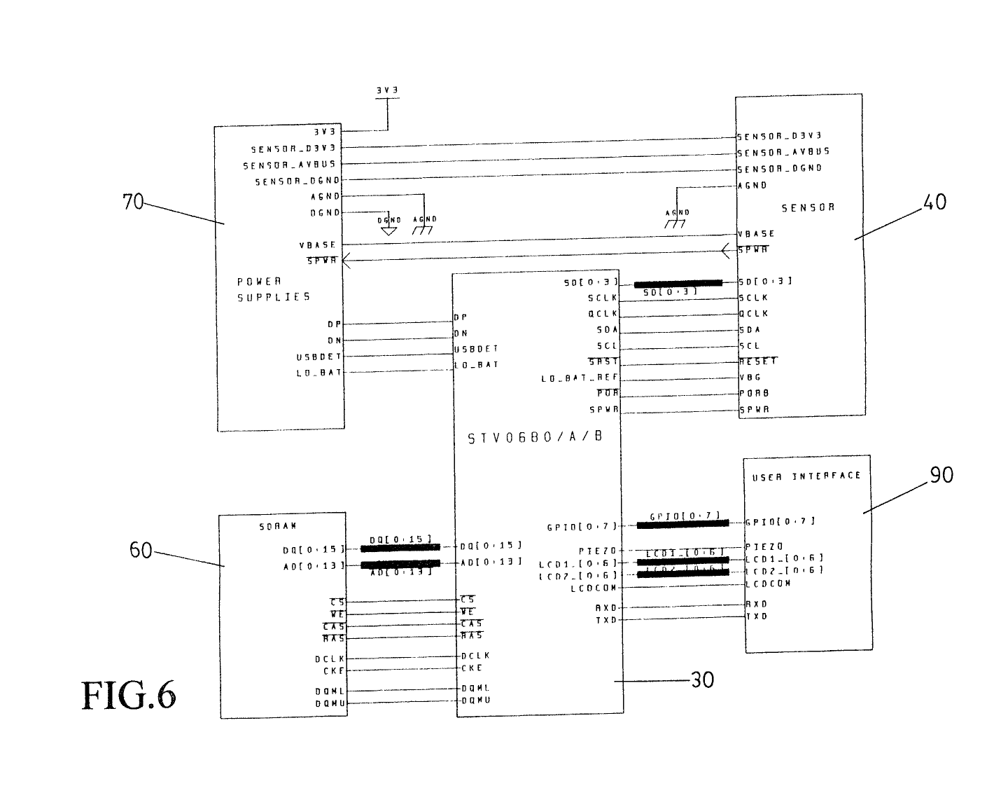

As shown in FIG. 6, the line design of the present invention may use the above-mentioned structure substantially, and may omit the unnecessary peripheral structure, so that the control circuit only includes a single-chip microprocessor 30, an input/output interface 90, an image sensor 40, and a memory 60. Thus, the control circuit may be made light, thin, and short, so that the control circuit may be received in the battery seat 10 easily, and the battery contained in the inner portion of the battery seat 10 may supply the required electric power, thereby forming a battery seat of a mobile telephone having the functions of a digital camera and a digital recorder.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An integrated battery seat of a mobile telephone, comprising:
a control circuit board, mounted in an inner portion of a battery seat, and including a microprocessor, a memory, an image sensor, and an input/output interface, thereby forming a digital camera and digital recorder circuit;
a lens telescopic base, mounted in the battery seat, and capable of springing outward, the lens telescopic base including an image sensing lens a viewfinder;
a recorder push button set and a record hole for forming a peripheral structure to provide a function of a digital recorder; and
a shutter button, for taking digital images;
wherein, the battery seat of the mobile telephone has the functions of a digital camera and a digital recorder.

2. The integrated battery seat of a mobile telephone in accordance with claim 1, wherein the battery seat has one side provided with a computer interface socket that is connected to the input/output interface of the control circuit board for connection with a computer.

3. The integrated battery seat of a mobile telephone in accordance with claim 1, wherein the battery seat is provided with a lens release button for controlling operation of the lens telescopic base.

4. The integrated battery seat of a mobile telephone in accordance with claim 1, wherein the battery seat is provided with an earphone hole for connection with an earphone.

5. The integrated battery seat of a mobile telephone in accordance with claim 1, wherein the microprocessor is a structure that may be used to capture images and may be used for digital recording.
